(19) United States
(12) Patent Application Publication
(10) Pub. No.: US 2008/0263361 A1
(43) Pub. Date: Oct. 23, 2008

(54) Cryptographically strong key derivation using password, audio-visual and mental means

(75) Inventors: Tanmoy Dutta, Sammamish, WA (US); Sunil Kadam, Redmond, WA (US); Tolga Acar, Sammamish, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/788,687

(22) Filed: Apr. 20, 2007

(51) Int. Cl. H04L 9/00

(52) U.S. Cl. 713/182

(57) ABSTRACT

A security system that uses a cryptographic key derived from human interaction with media. The system employs a set of parameters that includes user responses to graphical media and/or audio data, among other parameters. The architecture adds a fourth dimension to the conventional authentication means in order to make at least an offline attack on the key much more difficult. In addition to a standard set of parameters such as password, salt (random bits inserted into the encryption process) and iteration count, the system further utilizes information in the form of “what the user does” by presenting and prompting the user to interact with media in some way. The media can include audio information, video information, and/or image information, for example.

### BACKGROUND

Passwords have notoriously low entropy and are not adequate for strong cryptographic purposes. Nonetheless, passwords have been in use for decades for cryptographic means, in particular, for identification and authentication purposes. Most of the user authentication to computers, and in particular, web-based authentication, is based on username and password entry provided by the user. Even if the username is treated as an extension of a password for web-based authentication, the combined entropy still falls well below what is considered strong in cryptographic terms.

Computers excel at automated and repetitive tasks. One such application in cryptography is known as “exhaustive search”. A computer can try all possible passwords and determine if the correct password is found. Rainbow tables provide a significant improvement to password cracking. Online prevention mechanisms such as intrusion detection systems and a cap on the maximum incorrect password trials try to provide countermeasures against such password guessing attacks. However, offline attacks are always possible and do not trigger such countermeasures.

Efforts to interject the human element into the authentication process have been studied in order to prevent automated password cracking attempts. In one such method, a distorted image is presented on a display, and the user is asked to type in what is seen on the screen. The image is distorted in such a way so as to prevent computer recognition of the text in the image, such as optical image recognition methods. The goal of such an approach is to force the human element into the authentication process, significantly slowing down the automated password guessing attacks. More sophisticated protection mechanisms are in demand to protect against offline as well as online attacks.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture is a security system that uses a cryptographic key derived from a set of parameters that includes user responses to graphical media and/or audio data, among other parameters. The architecture adds a fourth dimension to the conventional authentication means in order to make at least an offline attack on the key much more difficult. Traditionally, authentication has been based on three things: what the user knows (e.g., password), what the user is (e.g., fingerprints), and what the user owns (e.g., smart card).

Continuing with similar phraseology, the disclosed architecture adds a fourth dimension of “what the user does”. This is related to human mental (or sensory) activity based on content (e.g., images, audio, video, etc.) presented to the user for solving.

In other words, in addition to a standard set of parameters such as password, salt (random bits inserted into the key derivation and encryption process) and iteration count, conventionally used to generate a key, the disclosed architecture further utilizes information in the form of “what the user does” by presenting and prompting the user to interact with media in some way. The media can include audio information, video information, and/or image information, for example.

More specifically, the media can be presented as a gallery (or list) of indexed images, for example, in response to which the user selects one or more of the images. The associated indexes of the selected images are then employed in the encryption process. Similarly, alternatively or in combination therewith, the media can be an indexed list of audio clips or files, for example, in response to which the user selects one or more of the audio information. The audio indexes associated with the selected audio information are then employed in the encryption process.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a security system for authentication processing in accordance with the disclosed architecture.

FIG. 2 illustrates a multi-dimensional key that includes a set of parameters for key generation.

FIG. 3 illustrates a flow diagram that employs indexed media as a value for creation of a cryptographic key.

FIG. 4 illustrates a flow diagram that employs mixed indexed media as a value for creation of a cryptographic key.

FIG. 5 illustrates an exemplary screenshot of a UI panel for password entry and perceived graphics.

FIG. 6 illustrates an exemplary screenshot of a UI panel for password entry and perceived graphics when a correct password is entered.

FIG. 7 illustrates an exemplary screenshot of a UI panel for password entry and perceived graphics when an incorrect password is entered.

FIG. 8 illustrates an exemplary hardware approach for storing and transporting the key(s).

FIG. 9 illustrates a method of providing security using image data in accordance with the disclosed architecture.

FIG. 10 illustrates a method of providing security using audio data in accordance with the disclosed architecture.

FIG. 11 illustrates a method of encryption processing using salt and iteration count.

FIG. 12 illustrates an alternative method of encryption processing.

FIG. 13 illustrates a block diagram of a computing system operable to provide and execute encryption processing in accordance with the disclosed architecture.

FIG. 14 illustrates a schematic block diagram of an exemplary computing environment for providing encryption processing in accordance with the disclosed architecture.

### DETAILED DESCRIPTION

The disclosed architecture is a security system that uses a cryptographic key derived from a set of parameters that includes user responses to graphical media, among other parameters. The architecture adds a fourth dimension to the conventional authentication means in order to make at least an offline attack on the key much more difficult. Traditionally, authentication has been based on three things: what the user knows (e.g., password), what the user is (e.g., fingerprints), and what the user owns (e.g., smart card). The disclosed architecture adds a fourth dimension of what the user “does”. This involves a human mental (or sensory) response to perceived content (e.g., images, audio, video, etc.) presented as an additional element of an authentication process. Mental activities in this scope include, but are not limited to, complex image recognition (e.g., a sequence of letters and numbers in a distorted or garbled manner but yet recognizable with some level of human understanding), audio recognition (e.g., listening to letters spoken in the presence of background noise and background chatter), and video recognition (e.g., a man in the video picks up an object such as a “cup”, and waves a hand three times with four finders opened), all of which can be presented for human interaction as a means of authentication.

Another benefit is to derive cryptography from identification and authentication (IA). Moreover, the goal of cryptography is extended to indirect IA purposes, such as encrypted e-mail (S/MIME).

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

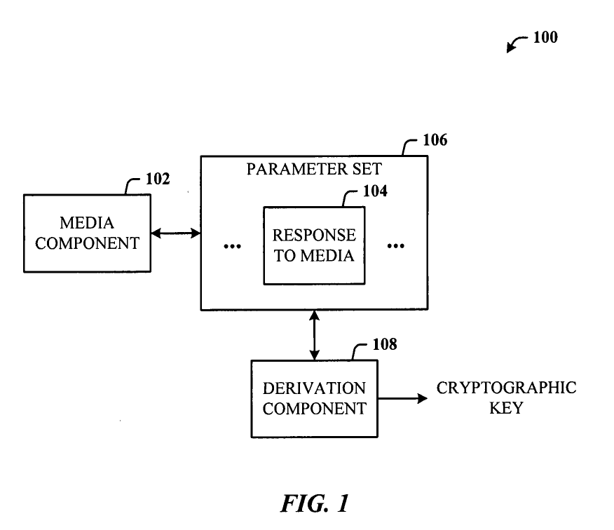

Referring initially to the drawings, FIG. 1 illustrates a security system 100 for authentication processing in accordance with the disclosed architecture. The system 100 includes a media component 102 for presenting graphical media, in response to which a user is prompted to select graphical information of the presented graphical media (the response to media information 104). The selected information is then included in a set of parameters 106, which set 106 is then processed as part of an authentication process. In support thereof, a derivation component 108 is provided for receiving the set of parameters 104 and deriving a cryptographic key based on the set of parameters 106 that includes the user response to the media 104.

In other words, in addition to a standard set of parameters such as password, salt (random bits inserted into the key derivation and encryption process) and iteration conventionally used to generate a key, the disclosed architecture further utilizes information in the form of “what the user does”, as described above, by presenting the user with media that prompts the user to respond in some way. The media can include audio information, video information, and/or image information, for example.

More specifically, the media can be presented as a gallery (or list) of indexed images, for example, in response to which the user selects one or more of the images. The associated indexes of the selected images are then employed in the encryption process. Similarly, alternatively or in combination therewith, the media can be an indexed list of audio clips or files, for example, in response to which the user selects one or more of the audio information. The audio indexes associated with the selected audio information are then employed in the encryption process.

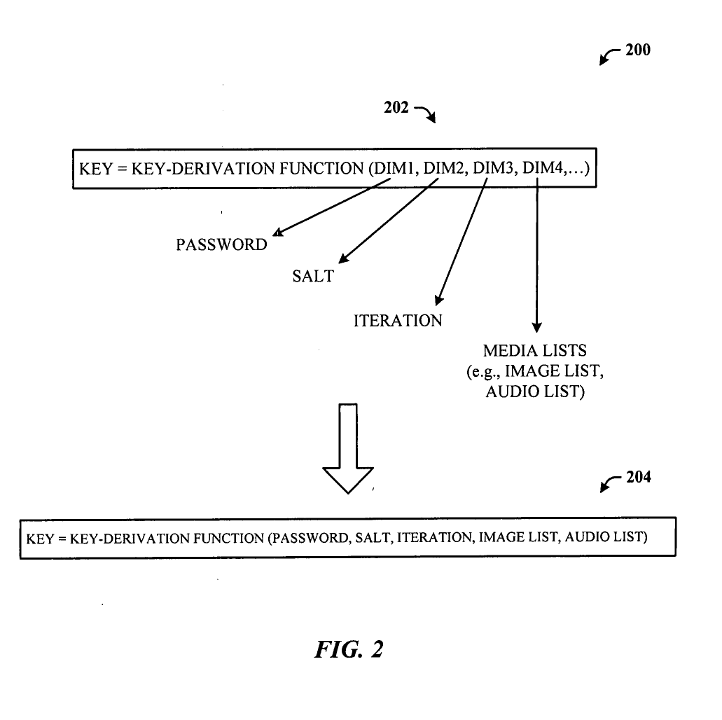

FIG. 2 illustrates a multi-dimensional key 200 that includes a set of parameters 202 for key generation. The set of parameters 202 includes multiple dimensions (denoted DIM1, DIM2, DIM3, DIM4, . . . ), where a first dimension (DIM1) can be a password, a second dimension (DIM2) can be salt, a third dimension (DIM3) can be iteration count data, a fourth dimension can be media lists, and so on. The key 200 is derived using a key derivation function (denoted KEY-DERIVATION FUNCTION( )) that operates on the set of parameters 202 once all values for the parameters are received. Of particular value in this implementation are the one or more media lists (e.g., audio list, video list, image list, etc.). The media lists provide the user “response to media 104” of FIG. 1.

The cryptographic key is derived using a number of different sources (e.g., user log-in, user interface (UI) responses to media, iteration settings, salt settings, and so on). In a more specific derivation, a key 204 is derived using a password, salt, iteration value, an image list, and audio list, and optionally, other information.

The key is a cryptographic key that can be used in a variety of ways, including authentication and key management. Salt and iteration counts can be traditional count values to the key derivation process to increase the workload of an attacker (e.g., offline), and which can be obtained using existing approaches. The goal is to improve the amount of entropy in the derived cryptographic key to prevent at least offline key guessing attacks.

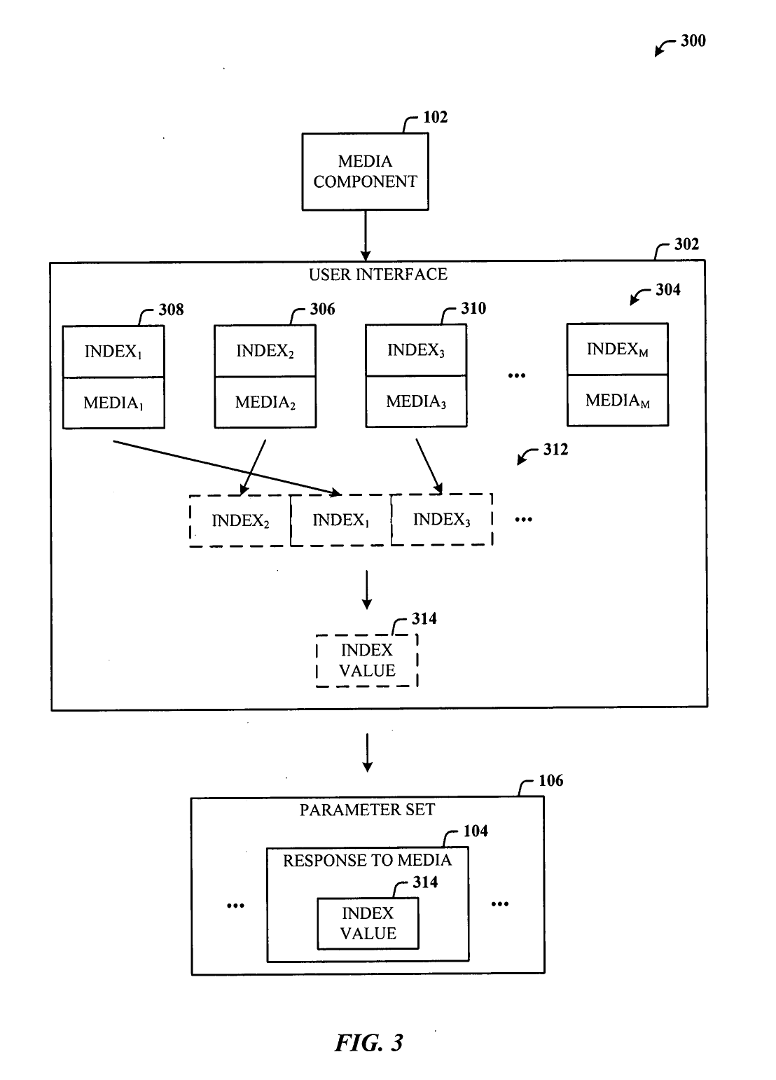

FIG. 3 illustrates a flow diagram 300 that employs indexed media as a value for creation of a cryptographic key. The diagram 300 begins with the media component 102 interacting with (or causing to be launched) a user interface (UI) 302. The UI 302 presents indexed media information 304. The indexed media information 304 includes the presentation of multiple items of the same type of media (denoted MEDIA₁, MEDIA₂, MEDIA₃, . . . , MEDIA_{M}, where M is a positive integer) each item having an associated corresponding index (denoted INDEX₁, INDEX₂, INDEX₃, . . . , INDEX_{M}).

In operation, the user selects one or more of the indexed media 304, and the associated index values are stored in the order of selection. For example, the user selects a second indexed media 306, then a first indexed media 308, and then a third indexed media 310, in that order. This creates an ordered set 312 of indexes (or indices) which is then stored as an index value 314. The value 314 can be the raw order indices or an encrypted version thereof.

The set 312 and value 314 are illustrated in dashed lines to indicate that these are not displayed in the UI 302 but are stored in a background process. However, it is to be appreciated that the set 312 and/or the value 314 could be presented as the user makes the media selections. The index value 314 is then passed into the parameter set 106 (as the response to media portion 104) on which the key-derivation function operates, ultimately generating the cryptographic key via the derivation component 108 of FIG. 1.

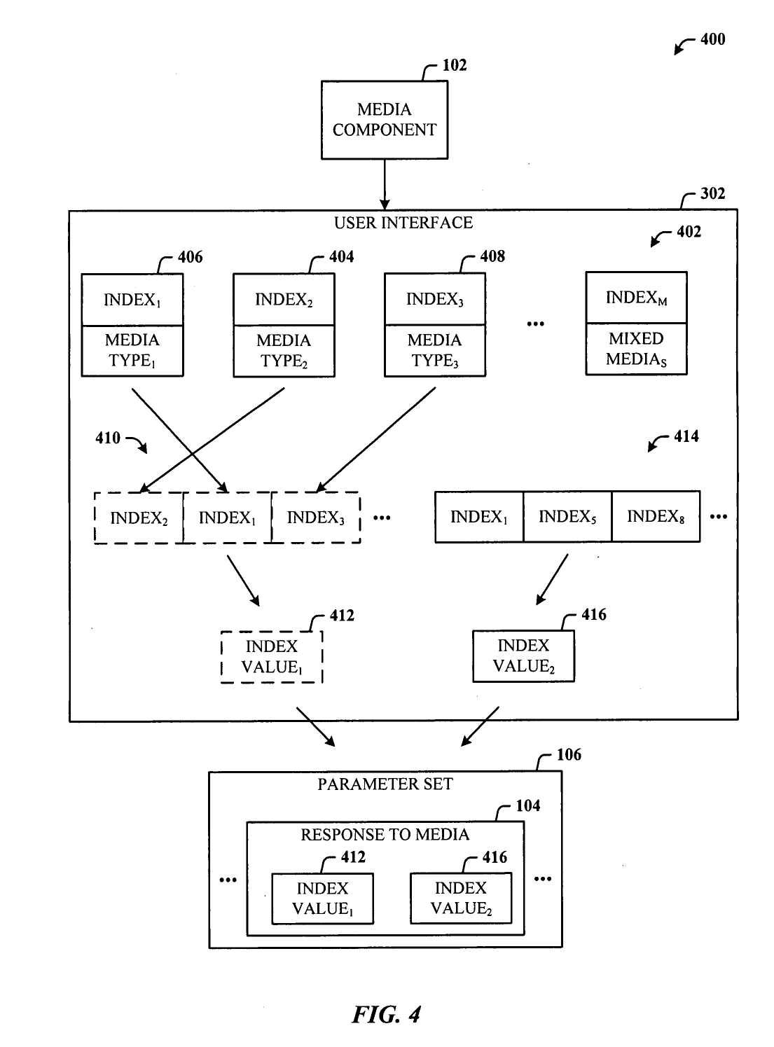

FIG. 4 illustrates a flow diagram 400 that employs mixed indexed media as a value for creation of a cryptographic key. The diagram 400 begins with the media component 102 interacting with (or causing to be launched) the UI 302. The UI 302 presents indexed mixed media information 402. The indexed mixed media information 402 includes the presentation of multiple items of the different types of media (denoted MIXED MEDIA₁, MIXED MEDIA₂, MIXED MEDIA₃, . . . , MIXED MEDIA_{S}, where S is a positive integer) each item having an associated corresponding index (denoted INDEX₁, INDEX₂, INDEX₃, . . . , INDEX_{M}). For example, the mixed media types 402 can include audio clips or files, images, video clips or files, etc.

In operation, the user selects one or more of the indexed mixed media 402, and the associated index values are stored in the order of selection. For example, the user selects a second indexed mixed media type 404, then a first indexed mixed media type 406, and then a third indexed mixed media type 408, in that order. This creates the first ordered set of indexes 410 which is then stored as a first index value 412.

The first set 410 and first value 412 are illustrated in dashed lines to indicate that these are not shown in the UI 302 but are stored in a background process. However, it is to be appreciated that the first set 410 and/or the first index value 412 could be presented in the UI 302. The index value 412 is then passed into the parameter set 106 (as the response to media portion 104) on which the key-derivation function operates, ultimately generating the cryptographic key via the derivation component 108 of FIG. 1.

It is within contemplation of the subject architecture that a second and different selection of mixed media can be made. The second selection includes a second set 414 of corresponding indexes (INDEX₁, INDEX₅, and INDEX₈) associated with the first mixed media type 406, a fifth mixed media type (not shown), and an eight mixed media type (not shown). The second set of indexes 414 is then used to create a second index value 416, which is then passed into the parameter set 106 as another of the response to media values 104, ultimately generating the cryptographic key via the derivation component 108 of FIG. 1.

The second set of indexes 414 is shown in solid lines, indicating that this set 414 and/or the second index value 416 can be made visible to the user via the UI 302. However, this can be made optional and configurable, for example.

As indicated, both the first index value 412 and the second index value 416 can be included as part of the parameter set 106 further improving the entropy of the generated key. Moreover, the index values (412 and 416) can be based on one type of media (e.g., only audio or only images), or multiple types of media (e.g., audio, video, and/or images). This implies that the selected media types 402 can be a blend of audio, images, and video, for example, further complicating the offline attack process on the key.

Following is a more detailed description of one implementation of the key in accordance with the disclosed architecture. The cryptographic key described can be utilized as a wrapping key which is used to protect other keys. The wrapping key is represented by K, and can be a symmetric AES (advanced encryption standard) key (e.g., 128-bit, 256-bit, etc.).

Key=Key-Derivation-Function(Password, Salt, Iteration, Image List, Audio List)

The “Password” can be a conventional low-entropy password the user enters and/or provided by other means (e.g., system login, network loin, UI login to the encryption process, etc.). The disclosed approach does not require the password complexity to be more than what a causal user would normally have in a password. Clearly, a more complex password improves the strength of the cryptographic key and is encouraged regardless of the other methods employed to improve entropy in the derived cryptographic key.

The password is represented as pw resulting in an interim conceptual key derivation equation with password as,

Key=Key-Derivation-Function(pw, Salt, Iteration, Image List, Audio List)

For “Image List” a particular permutation of a set of images selected by the user contributes a significant amount of entropy and cannot be automated in an offline manner in a feasible way.

Let I represent the set of all images. Let S represent an ordered subset of the image set L Thus, S is a permutation subset of I. One approach feeds the interpreted contents of the ordered subset S to the key derivation. A human can then interpret each image in S, and provide an interpreted result to the key derivation subsystem. Note that this is not the image itself, but the interpreted image fed to the key derivation process by interjecting the human element into the key derivation process. The size of the image subset S increases the contributed entropy, and can be adjusted as needed. For example, the subset S size can be set by an enterprise policy, by an administrator, by the user, or a combination thereof, in real-life scenarios.

An image can be represented in the ordered image subset S as Sᵢ, such that SᵢεS, where 0≦i<|S|. Let Sᵢ^{h} represent human-interpreted content of image Sᵢ, and S^{h} represent the ordered set of human-interpreted results. The key derivation with password and interpreted images then becomes,

Key=Key-Derivation-Function(pw, Salt, Iteration, S^{h}, Audio List)

A similar approach is provided with audio media. Let A represent an ordered subset of the entire audio set. Thus, A is a permutation subset of all audio. This approach feeds the interpreted contents of the ordered subset A to the key derivation process. A human (e.g., the user) interprets each audio data in A, and provides the interpreted result to the key derivation process.

An audio is represented in the ordered audio subset A with Aᵢ, such that AᵢεA, where 0≦i<|A|. Let Aᵢ^{h} represent a human-interpreted content of audio Aᵢ, and A^{h} represent the ordered set of human-interpreted results. The key derivation with password, interpreted image and audio then becomes,

Key=Key-Derivation-Function(pw, Salt, Iteration, S^{h}, A^{h})

Displaying a large number of images to the user and asking the user to create a subset, and then asking the user to remember the exact same subset can be onerous. Furthermore, asking the same user to remember the order of the selected subset can be a huge burden in the performance of daily activities, perhaps with some exceptions. The disclosed architecture provides a scheme that is usable by the majority of users without imposing a significant inconvenience, while still improving security.

Rather than asking the user to select an ordered subset and then interpreting each image and audio in the selected subset, the selected subset is encrypted in a novel way. In other words, the password, salt, and an iteration count are employed in the encryption process. The contents of the images or audio, for example, are not encrypted; but instead, the permutation of the images and/or the audio information is encrypted. Effectually, what is encrypted is a string of numbers; more precisely, one or more sets of numbers. The one or more of the sets of number can include the ordered index of images and/or the ordered set of audio.

However, in a more robust implementation, in order to provide another level of difficulty, the plain index that is between zero and the order of image and audio sets is not stored, but a number that is in the equivalence class of that index. More specifically, an integral multiple of the set ordered to the index is encrypted to remove a checkpoint to the cryptanalyst.

Recall that A and S are used to represent the respective ordered sets of audio and images. Let Aⁱ and Sⁱ represent the ordered indices. The sets A and S are not used this approach, but instead, Aⁱ and Sⁱ are used.

Let aᵢεAⁱ and sⱼεSⁱ, that is, 0≦aᵢ<|Aⁱ| and 0≦sⱼ<|Sⁱ|. Observe that |Aⁱ|=|A| and |Sⁱ|=|S|. Accordingly, at enrollment time, the user is prompted to enter a password pw. A relatively large set of images is randomly generated and displayed, and the user is prompted select a subset thereof, creating S. Optionally, a number of audio files can be presented and the user asked to select a subset, creating A.

Next, a key Kₚ is created using a generated random number, a key derived from the password pw, and a large iteration count.

With respect to encryption of the image and audio indices, each index is represented in radix 2^{w}, where w is typically a power of 2. Assume that w=32 for a 32-bit computer. Note that 2³² is sufficiently large to contain the largest possible index in an image and audio subset.

Add an integral multiple of |A| and |S| to each aᵢ and sⱼ, respectively.

aᵢ=aᵢ+rᵢ^{A}·|A|

sⱼ=sⱼ+rⱼ^{S}·|S|

The set of indices is then encrypted by Kₚ, in EBC (electronic code book) mode of operation with a block cipher. In an exhaustive search method, this approach does not provide a checkpoint to a cryptanalyst without further using the decrypted indices. An attempt to reorder the ciphertext blocks results in an incorrect key to be derived and would not provide useful information to an attacker. The encrypted ordered index set is stored along with the unencrypted, large set of images and audio.

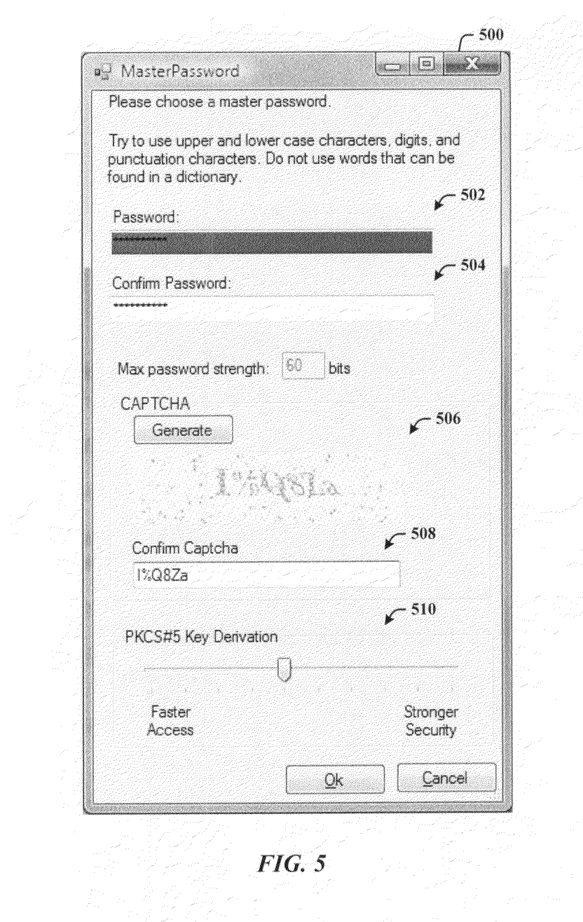

FIG. 5 illustrates an exemplary screenshot of a UI panel 500 for password entry and perceived graphics. The panel 500 shows a password field 502 and password confirmation field 504 where the user enters a password, and a challenge-response text 506 (e.g., CAPTCHA-Completely Automated Public Turing test to tell Computers and Humans Apart) is automatically generated for the user. The user enters the text 506 presented on the screen into a Confirm field 508 using visual and mental capabilities for confirmation. The idea is to remove the computer from the image recognition and interpretation chain.

In other words, based on the media types and corresponding ordered set of indices, for example, consider the ordered index of 150763 (e.g., on a scale beginning with zero; becomes the 2^{nd} image, 6^{th} image, 1^{st} image, 8^{th} image, 7^{th} image, and 4^{th} image), a randomization based on 150763 creates the CAPTCHA graphic 506 with an indirect mapping of 1→I, 5→%, 0→Q, 7→8, 6→Z, and 3→a. Thus, the S and A parameters of the generator can be encrypted. Here, the CAPTCHA graphic 506 is I % Q8Za and the user enters what is perceived into the Confirm field 508. The security strength can be manipulated by moving a slider control 510 between faster access (a weaker security measure) and stronger security (by controlling stronger key derivation).

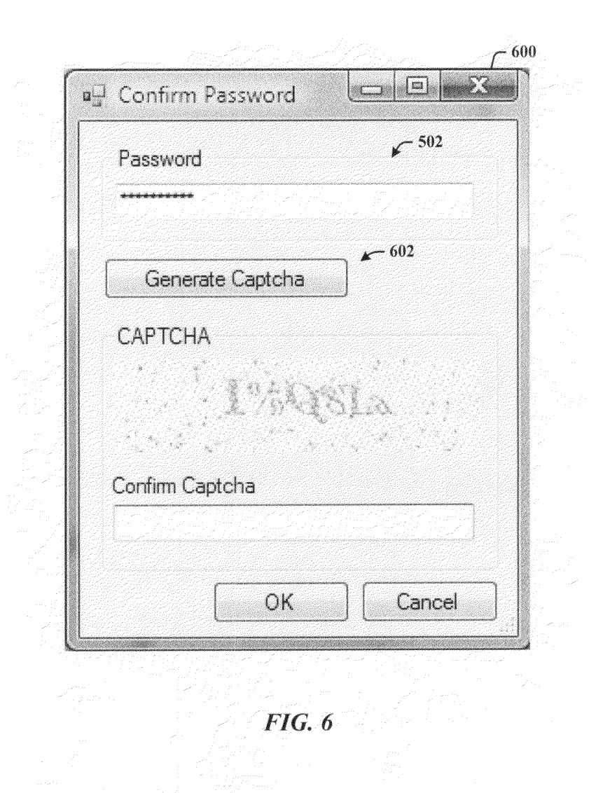

FIG. 6 illustrates an exemplary screenshot of a UI panel 600 for password entry and perceived graphics when a correct password is entered. The screenshot is presented to the user before the CAPTCHA graphic 506 of FIG. 5 is displayed. The user enters a password into the password field 502, and selects a “Generate” button 602 to generate the CAPTCHA image 506. The image below displays the case when the entered password is the correct password, in which case, the CAPTCHA contains the string (I % Q8Za) that the user would enter to derive the intended correct key.

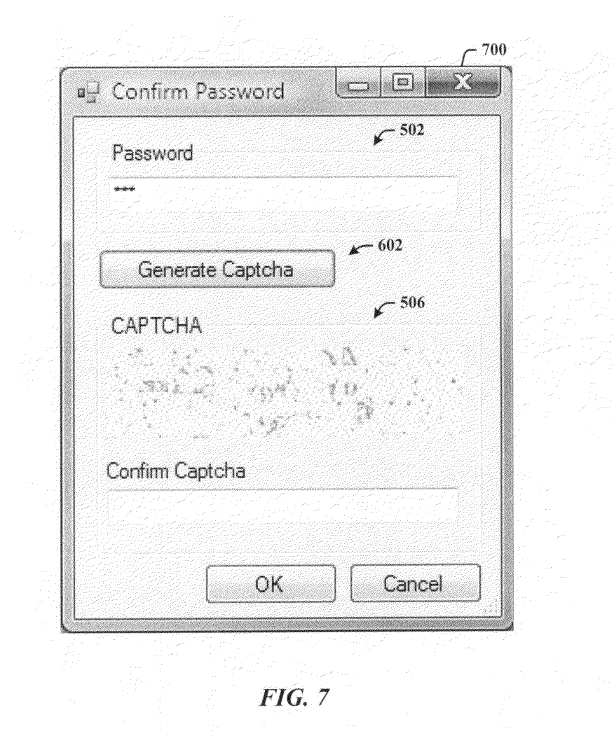

FIG. 7 illustrates an exemplary screenshot of a UI panel 700 for password entry and perceived graphics when an incorrect password is entered. Before an understandable CAPTCHA graphic 506 is generated, the user must enter the correct password. The panel 700 shows the case when the password entered into the password field 502 is not the correct password, in which case, the CAPTCHA graphic 506 contains either a random (garbled) image, or in another implementation, another string for the user to see, interpret, and enter. However, in this case, the interpreted string by the user is not the correct string, unlike the case above. Thus, the derived key would not be the correct cryptographic key.

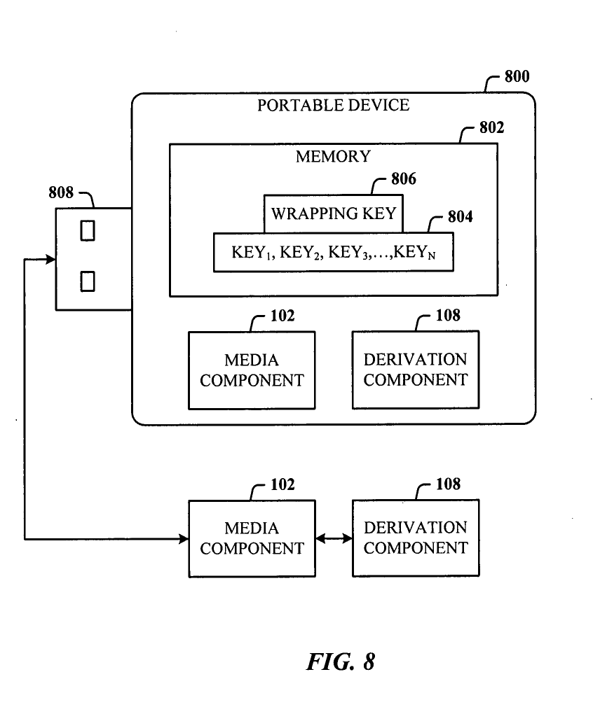

FIG. 8 illustrates an exemplary hardware approach for storing and transporting the key(s). In one embodiment, a portable memory device 800 such as a USB token can be used to store and transport a user's cryptographic keys. The device 800 can include a non-volatile memory 802 (e.g., flash, ROM, etc.) for storing one or more keys 804, which keys can be further protected by a wrapping key 806. When the device 800 is a USB device, an interface 808 facilitates interfacing to a USB compatible device (e.g., a computer). Where the device 800 is wireless, the interface 808 can be a transceiver component that includes an antenna for wireless communication access and storing of data. The device 800 can also be a microdrive such that the memory 802 is a rotational hard drive or static flash drive, for example. In such a case, the interface 808 provides suitable interface and connectivity for compatible systems (e.g., portable computer, desktop computer, PDA, portable music player, and/or applications thereof, etc).

The portable device 800 can also store the media component 102 and/or derivation component 108 such that once the user has gained access, these components (102 and/or 108) will operate as intended to provide the functionality described herein. For example, the media component 102 can launch and provide the UI for changing, updating, and/or creating new keys. Alternatively, or in combination therewith, the media component 102 and/or derivation component 108 can reside externally to the device 800 such that either or both are launched to facilitate user access to the wrapping key 806 and wrapped keys 804 for changing, updating, and/or creating new keys.

The keys are typically used for authentication purposes as well as encrypted and signed e-mail purposes, for example. An arbitrary set and type of cryptographic keys can be stored on this device. In an alternative implementation, the memory device can be a passive or active wireless device (e.g., RFID-radio frequency identification, Bluetooth, etc.) that downloads the key(s) to a computing system, for example. Protection can be provided by a cryptographic wrapping key derived as described above. The wrapping key can be a symmetric key, such as an AES-256 key.

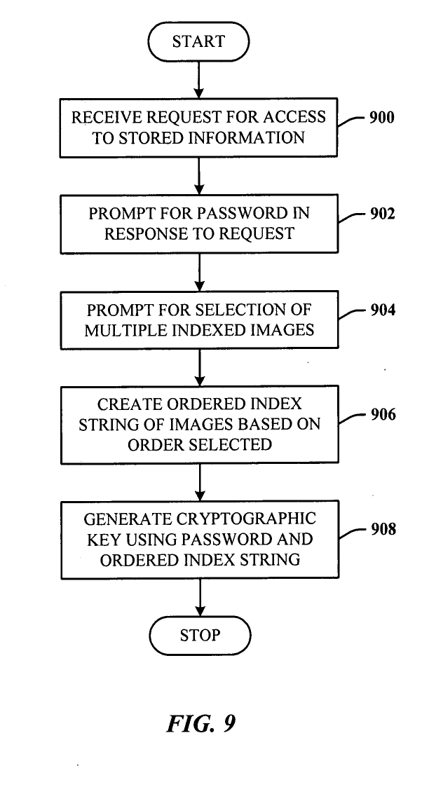

FIG. 9 illustrates a method of providing security using image data in accordance with the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

At 900, a request is received for access to stored information. At 902, in response to the request, the system prompts (e.g., a user) for a password. At 904, based upon successful password input, a user is prompted to select multiple indexed images (e.g., a subset) of a set of indexed images. At 906, an ordered index string of the images is created based on the order in which the images were selected. At 908, a cryptographic key is generated using the password and ordered index string.

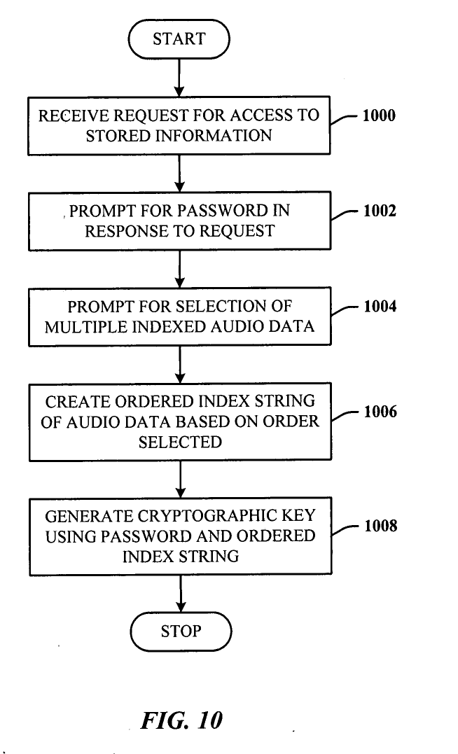

FIG. 10 illustrates a method of providing security using audio data in accordance with the disclosed architecture. At 1000, a request is received for access to stored information. At 1002, in response to the request, the system prompts (e.g., a user) for a password. At 1004, based upon successful password input, a user is prompted to select multiple indexed audio data (e.g., a subset) of a set of indexed audio data. At 1006, an ordered index string of the audio data is created based on the order in which the audio data was selected. At 1008, a cryptographic key is generated using the password and ordered index string.

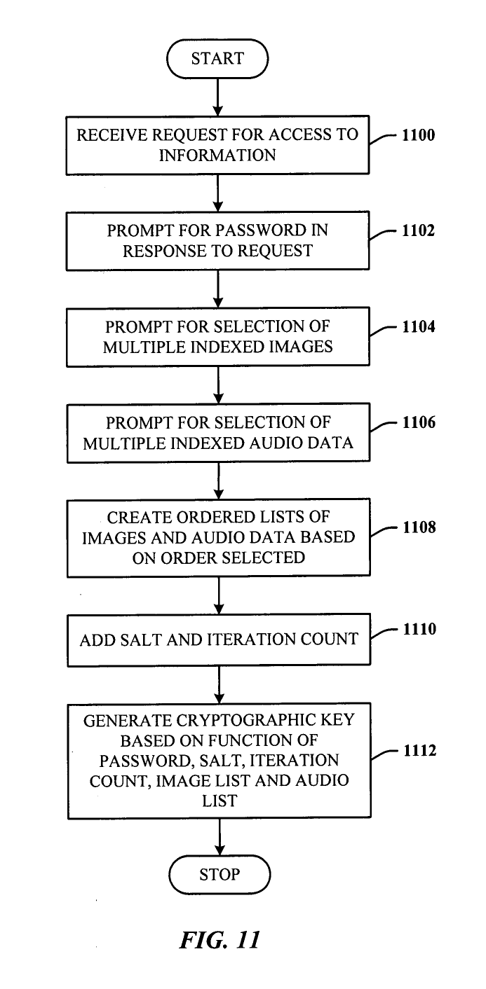

FIG. 11 illustrates a method of encryption processing using salt and iteration count. At 1100, a request is received for access to information. At 1102, the user prompted for a password in response to the request. At 1104, the user is prompted to make a selection of a subset of images from a set of the images. At 1106, the user is prompted to make a selection of a subset of audio data from a set of the audio data. At 1108, ordered lists of the images indices and audio data indices are created, in the order selected. At 1110, salt and iteration count are added. At 1112, a cryptographic key is added based on a function of the password, salt, iteration count, image list and audio list.

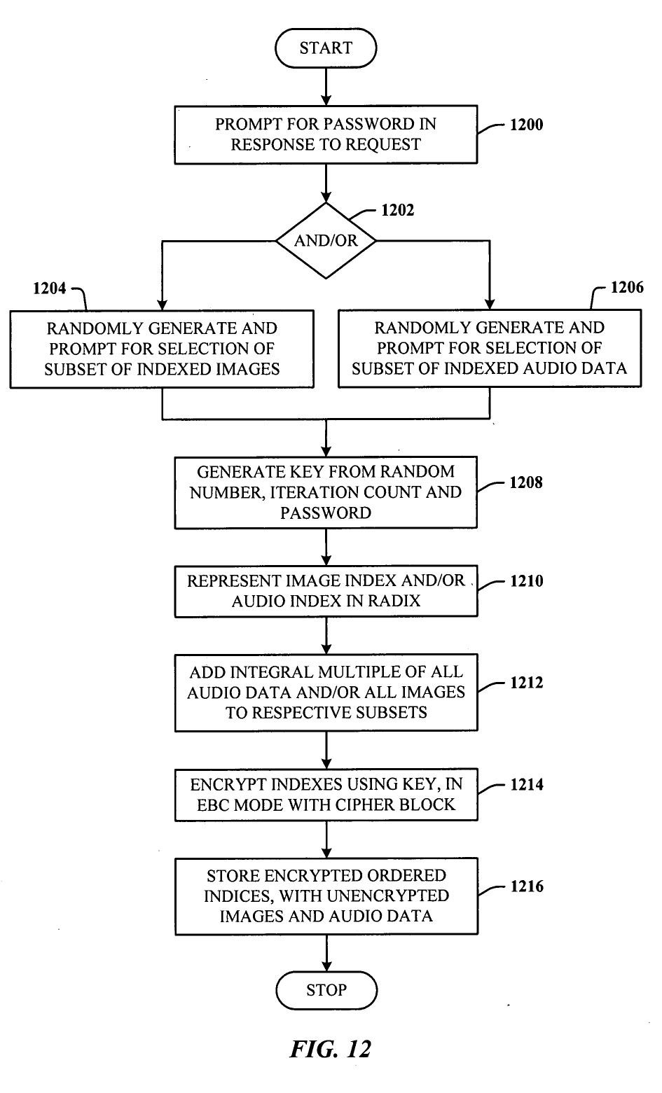

FIG. 12 illustrates an alternative method of encryption processing. At 1200, a request is received and a user is prompted for a password. At 1202, the user can be prompted to from images and/or audio data. At 1204, a set of images is randomly generated and the user is prompted for selection of a subset of the images. Alternatively, or in combination therewith, at 1206, a set of audio data is randomly generated and the user is prompted for selection of a subset of the audio data based on hearing the audio data. At 1208, a key is generated from a random number, an iteration count, and password. At 1210, the selected index of the image and/or audio index are represented in radix. At 1212, an integral multiple of all the audio data and/or the image data is added to respective subsets. At 1214, the indexes are encrypted using the key, in EBC mode of operation and with a cipher block. At 1216, the encrypted ordered indices are stored with unencrypted subsets of images and/or audio data.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

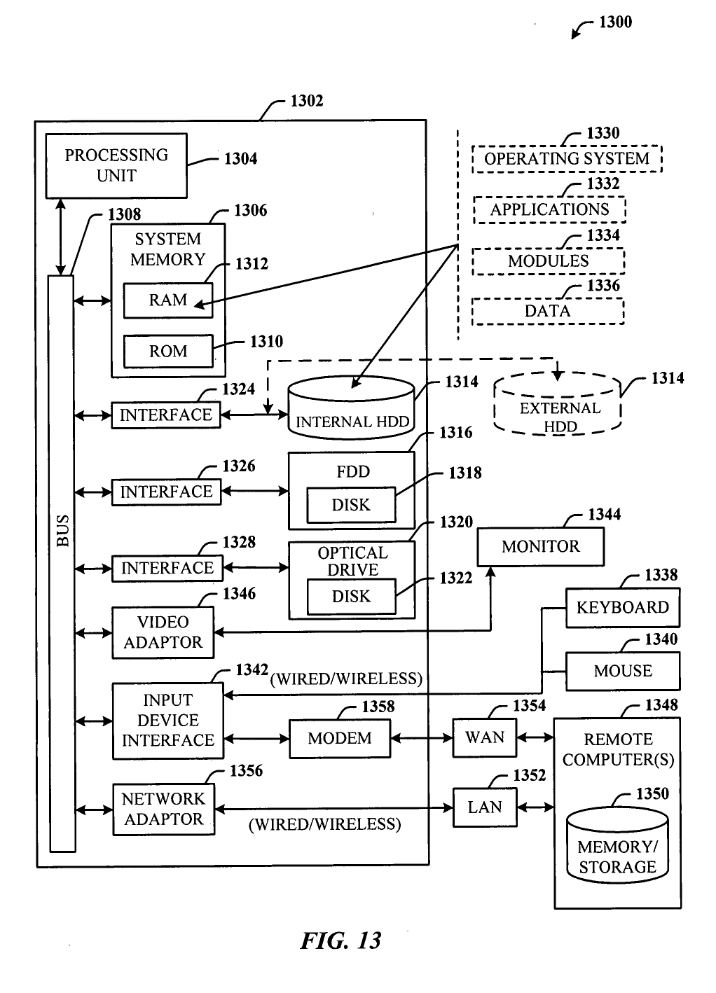

Referring now to FIG. 13, there is illustrated a block diagram of a computing system 1300 operable to provide and execute encryption processing in accordance with the disclosed architecture. In order to provide additional context for various aspects thereof, FIG. 13 and the following discussion are intended to provide a brief, general description of a suitable computing system 1300 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 13, the exemplary computing system 1300 for implementing various aspects includes a computer 1302, the computer 1302 including a processing unit 1304, a system memory 1306 and a system bus 1308. The system bus 1308 provides an interface for system components including, but not limited to, the system memory 1306 to the processing unit 1304. The processing unit 1304 can be any of various commercially available processors. Dual microprocessors and other multi-processor architectures may also be employed as the processing unit 1304.

The system bus 1308 can be any of several types of bus structure that may further interconnect to a memory bus (with or without a memory controller), a peripheral bus, and a local bus using any of a variety of commercially available bus architectures. The system memory 1306 includes read-only memory (ROM) 1310 and random access memory (RAM) 1312. A basic input/output system (BIOS) is stored in a non-volatile memory 1310 such as ROM, EPROM, EEPROM, which BIOS contains the basic routines that help to transfer information between elements within the computer 1302, such as during start-up. The RAM 1312 can also include a high-speed RAM such as static RAM for caching data.

The computer 1302 further includes an internal hard disk drive (HDD) 1314 (e.g., EIDE, SATA), which internal hard disk drive 1314 may also be configured for external use in a suitable chassis (not shown), a magnetic floppy disk drive (FDD) 1316, (e.g., to read from or write to a removable diskette 1318) and an optical disk drive 1320, (e.g., reading a CD-ROM disk 1322 or, to read from or write to other high capacity optical media such as the DVD). The hard disk drive 1314, magnetic disk drive 1316 and optical disk drive 1320 can be connected to the system bus 1308 by a hard disk drive interface 1324, a magnetic disk drive interface 1326 and an optical drive interface 1328, respectively. The interface 1324 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 1302, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and RAM 1312, including an operating system 1330, one or more application programs 1332, other program modules 1334 and program data 1336. The one or more application programs 1332, other program modules 1334 and program data 1336 can include the media component 102 and derivation component 108, the password, salt, iteration count, images, video data, and audio data, for example.

All or portions of the operating system, applications, modules, and/or data can also be cached in the RAM 1312. It is to be appreciated that the disclosed architecture can be implemented with various commercially available operating systems or combinations of operating systems.

A user can enter commands and information into the computer 1302 through one or more wire/wireless input devices, for example, a keyboard 1338 and a pointing device, such as a mouse 1340. Other input devices (not shown) may include a microphone, an IR remote control, a joystick, a game pad, a stylus pen, touch screen, or the like. These and other input devices are often connected to the processing unit 1304 through an input device interface 1342 that is coupled to the system bus 1308, but can be connected by other interfaces, such as a parallel port, an IEEE 1394 serial port, a game port, a USB port, an IR interface, etc. The device 800 can interface to the computing system 1302 via the interface 1342 for media component 102 and derivation component 108 operations and functionality.

A monitor 1344 or other type of display device is also connected to the system bus 1308 via an interface, such as a video adapter 1346. In addition to the monitor 1344, a computer typically includes other peripheral output devices (not shown), such as speakers, printers, etc.

The computer 1302 may operate in a networked environment using logical connections via wire and/or wireless communications to one or more remote computers, such as a remote computer(s) 1348. The remote computer(s) 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wire/wireless connectivity to a local area network (LAN) 1352 and/or larger networks, for example, a wide area network (WAN) 1354. Such LAN and WAN networking environments are commonplace in offices and companies, and facilitate enterprise-wide computer networks, such as intranets, all of which may connect to a global communications network, for example, the Internet.

When used in a LAN networking environment, the computer 1302 is connected to the local network 1352 through a wire and/or wireless communication network interface or adapter 1356. The adaptor 1356 may facilitate wire or wireless communication to the LAN 1352, which may also include a wireless access point disposed thereon for communicating with the wireless adaptor 1356.

When used in a WAN networking environment, the computer 1302 can include a modem 1358, or is connected to a communications server on the WAN 1354, or has other means for establishing communications over the WAN 1354, such as by way of the Internet. The modem 1358, which can be internal or external and a wire and/or wireless device, is connected to the system bus 1308 via the serial port interface 1342. In a networked environment, program modules depicted relative to the computer 1302, or portions thereof, can be stored in the remote memory/storage device 1350. It will be appreciated that the network connections shown are exemplary and other means of establishing a communications link between the computers can be used.

The computer 1302 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

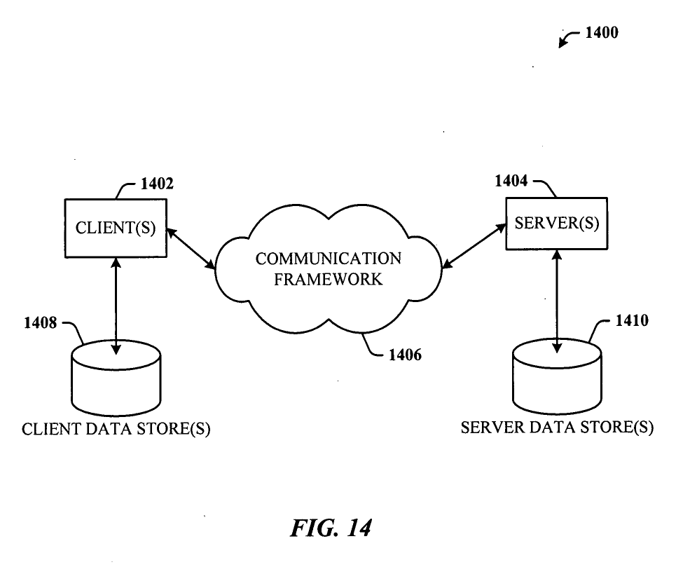

Referring now to FIG. 14, there is illustrated a schematic block diagram of an exemplary computing environment 1400 for providing encryption processing in accordance with the disclosed architecture. The system 1400 includes one or more client(s) 1402. The client(s) 1402 can be hardware and/or software (e.g., threads, processes, computing devices). The client(s) 1402 can house cookie(s) and/or associated contextual information, for example.

The system 1400 also includes one or more server(s) 1404. The server(s) 1404 can also be hardware and/or software (e.g., threads, processes, computing devices). The servers 1404 can house threads to perform transformations by employing the architecture, for example. One possible communication between a client 1402 and a server 1404 can be in the form of a data packet adapted to be transmitted between two or more computer processes. The data packet may include a cookie and/or associated contextual information, for example. The system 1400 includes a communication framework 1406 (e.g., a global communication network such as the Internet) that can be employed to facilitate communications between the client(s) 1402 and the server(s) 1404.

Communications can be facilitated via a wire (including optical fiber) and/or wireless technology. The client(s) 1402 are operatively connected to one or more client data store(s) 1408 that can be employed to store information local to the client(s) 1402 (e.g., cookie(s) and/or associated contextual information). Similarly, the server(s) 1404 are operatively connected to one or more server data store(s) 1410 that can be employed to store information local to the servers 1404.

The device 800 of FIG. 8 can be utilized to protect against unauthorized access to the client 1402 hardware and/or software applications, for example. Similarly, device 800 of FIG. 8 can be utilized to protect against unauthorized access to the server 1404 hardware and/or software applications. Yet again, the device 800 can be used to connect to the client 1402 and authenticate the client 1402 to the server 1404. The can occur using a wire and/or wireless technology.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A security system, comprising:
a media component for presenting graphical media, a user response to the media which is employed as part of an authentication process; and,
a derivation component for deriving a cryptographic key based on a set of parameters that includes the user response to the media.

2. The system of claim 1, wherein the media of the media component includes audio information.

3. The system of claim 2, wherein the media component presents a list of audio information, a subset of the list which is utilized for the authentication processing.

4. The system of claim 1, wherein the media of the media component includes image information.

5. The system of claim 4, wherein the media component presents a list of image information, a subset of the list which is utilized for the authentication processing.

6. The system of claim 1, wherein the key is a symmetric key.

7. The system of claim 1, wherein the media component presents a list of audio information and a list of image information, the index numbers of which are utilized for the authentication process.

8. The system of claim 1, wherein the media component and derivation component are stored on a portable memory device

9. A method of providing security, comprising:
receiving a request for access to stored information;
prompting for a password in response to the request;
prompting for selection of multiple indexed images;
creating an ordered index string of the images based on an order in which the images are selected; and,
generating a cryptographic key using the password and the ordered index string.

10. The method of claim 9, further comprising encrypting the ordered index string based on a key derived from a random number, the password, and an iteration count.

11. The method of claim 10, further comprising encrypting the ordered index string in an EBC (electronic code book) mode of operation using a block cipher.

12. The method of claim 9, further comprising generating the cryptographic key based on the password, salt, iteration count, and at least one of an image list or an audio list.

13. The method of claim 9, further comprising prompting for selection of multiple indexed audio data and creating an ordered index string of the audio data based on an order in which the audio data are selected.

14. The method of claim 13, further comprising encrypting an integral multiple of the ordered index string of the audio data and the ordered index string of the images to create an encrypted ordered set and to remove a checkpoint.

15. The method of claim 14, further comprising storing the encrypted ordered set with unencrypted audio data and images.

16. The method of claim 9, further comprising randomly generating a set of the multiple indexed images and selecting a subset of the multiple indexed images.

17. The method of claim 9, further comprising representing the ordered string index as a radix number and adding an integral multiple of the multiple indexed images.

18. The method of claim 9, further comprising presenting a distorted but human-readable graphic in response to receipt of a correct password, the graphic unrecognizable using computer recognition.

19. The method of claim 9, further comprising presenting distorted but human-understandable audio in response to receipt of a correct password, the audio unrecognizable using computer recognition.

20. A computer-implemented system, comprising:
computer-implemented means for receiving a request for access to stored information;
computer-implemented means for prompting for a password in response to the request;
computer-implemented means for prompting for selection of multiple indexed images;
computer-implemented means for creating an ordered index string of the images based on an order in which the images are selected; and,
computer-implemented means for generating a cryptographic key using the password and the ordered index string.
